(19) United States
(12) Patent Application Publication
(10) Pub. No.: US 2018/0101061 A1
(43) Pub. Date: Apr. 12, 2018

(54) BACKLIGHT MODULE AND LIQUID CRYSTAL DISPLAY

(71) Applicant: Shenzhen China Star Optoelectronics Technology Co., Ltd., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 15/104,253

(22) PCT Filed: May 17, 2016
(86) PCT No.: PCT/CN2016/082301

§ 371 Date: Jun. 14, 2016

(30) Foreign Application Priority Data
Apr. 5, 2016 (CN) 201610205893.2

(51) Int. Cl. G02F 1/1335; G02F 1/1333

(52) U.S. Cl. CPC G02F 1/133603; G02F 1/133308; G02F 2001/133314; G02F 1/133605; G02F 1/133608

(57) ABSTRACT

A backlight module and a liquid crystal display are disclosed. The backlight module includes: a back plate including multiple concave units arranged as a matrix; and a light source disposed at an inner bottom surface of each concave unit. Through above way, the present invention is capable of increasing the light controlling ability of the liquid crystal display and increasing the dynamic contrast ratio of the displayed picture.

### BACKGROUND OF THE INVENTION

### 1. Field of the Invention

The present invention relates to a display technology, and more particularly to a backlight module and a liquid crystal display.

### 2. Description of Related Art

In a conventional TFT-LCD (thin film transistor-liquid crystal display), because, a TFT-LCD panel does not emit light itself, an additional light source is required to perform a display. Usually, two types of light sources, a backlight type light source and a reflective type light source are provided. Because the backlight type light source will not be affected by the environment so that the light source in the TFT-LCD is almost a backlight type light source currently.

In the backlight source of the TFT-LCD, the light source becomes an LED (Light Emitting Diode) light source from a CCFL (Cold Cathode Fluorescent Lamp) light source. Because the LED has many advantages of small volume, fast response time, long life, non-friable, high color gamut, many kinds of package, the LED has become a mainstream of the backlight source. The LED backlight can be divided into a side-light type backlight and a direct-light type backlight.

Wherein, the direct-light type backlight is widely applied because of small number of light sources, no light guide plate and lower cost. However, among the light sources, a mutual interference is easily generated such that a light controlling ability of the liquid crystal display device is decreased so as to decrease a dynamic contrast ratio of the liquid crystal display device.

### SUMMARY OF THE INVENTION

The main technology problem solved by the present invention is to provide a backlight module and a liquid crystal display, capable of increasing the light controlling ability of the liquid crystal display and increasing the dynamic contrast ratio of the liquid crystal display.

In order to solve the above technology problem, a technology solution adopted by the present invention is: providing a backlight module, comprising: a back plate including multiple concave units arranged as a matrix; and a light source disposed at an inner bottom surface of each concave unit.

Wherein, the backlight module further comprises: a reflective sheet disposed at an inner side surface of each concave unit.

Wherein, each concave unit is surrounded and formed by multiple side surfaces and a bottom surface, an area of an opening of the concave unit is greater than an area of the bottom surface.

Wherein, the bottom surface is a flat surface or an arcuate surface, and the light source is disposed at a center of the bottom surface; or the bottom surface is a bent structure, and the light source is disposed at a bending location of the bottom surface.

Wherein, each side surface is a flat surface or an arcuate surface.

Wherein, the number of the side surfaces is four, and both the bottom surface and the opening are rectangular.

Wherein, further comprises: a diffusion plate disposed above openings of the multiple concave units; and an optical film disposed at a side of the diffusion plate away from the multiple concave units.

Wherein, the multiple concave units of the back plate are formed through stamping.

Wherein, openings of every adjacent two of the multiple concave units are connected smoothly.

In order to solve the above technology problem, another technology solution adopted by the present invention is: providing a liquid crystal display including a display panel and a backlight module, wherein, the backlight module comprises: a back plate including multiple concave units arranged as a matrix; and a light source disposed at an inner bottom surface of each concave unit.

Wherein, the backlight module further comprises: a reflective sheet disposed at an inner side surface of each concave unit.

Wherein, each concave unit is surrounded and formed by multiple side surfaces and a bottom surface, an area of an opening of the concave unit is greater than an area of the bottom surface.

Wherein, the bottom surface is a flat surface or an arcuate surface, and the light source is disposed at a center of the bottom surface; or the bottom surface is a bent structure, and the light source is disposed at a bending location of the bottom surface.

Wherein, each side surface is a flat surface or an arcuate surface.

Wherein, the number of the side surfaces is four, and both the bottom surface and the opening are rectangular.

Wherein, further comprises: a diffusion plate disposed above openings of the multiple concave units; and an optical film disposed at a side of the diffusion plate away from the multiple concave units.

Wherein, the multiple concave units of the back plate are formed through stamping.

Wherein, openings of every adjacent two of the multiple concave units are connected smoothly.

The beneficial effects of the present invention are: comparing to the conventional art, the backlight module of the present invention comprises a back plate and a light source, wherein, the back plate includes multiple concave units arranged as a matrix; and the light source disposed at an inner bottom surface of each concave unit. The present invention can avoid a mutual interference of light between adjacent two concave units, capable of increasing the light controlling ability of the liquid crystal display and increasing the dynamic contrast ratio of a displayed picture.

### BRIEF DESCRIPTION OF THE DRAWINGS

FIG. 1 is a side view of a structure of a backlight module of a first embodiment of the present invention;

FIG. 2 is a top view of the structure of the backlight module of the first embodiment of the present invention;

FIG. 3 is a side view of another structure of the backlight module of the first embodiment of the present invention;

FIG. 4 is a side view of a structure of a backlight module of a second embodiment of the present invention;

FIG. 5 is a top view of the structure of the backlight module of the second embodiment of the present invention; and

FIG. 6 is a schematic diagram of a liquid crystal display of an embodiment of the present invention.

### DETAILED DESCRIPTION OF THE PREFERRED EMBODIMENT

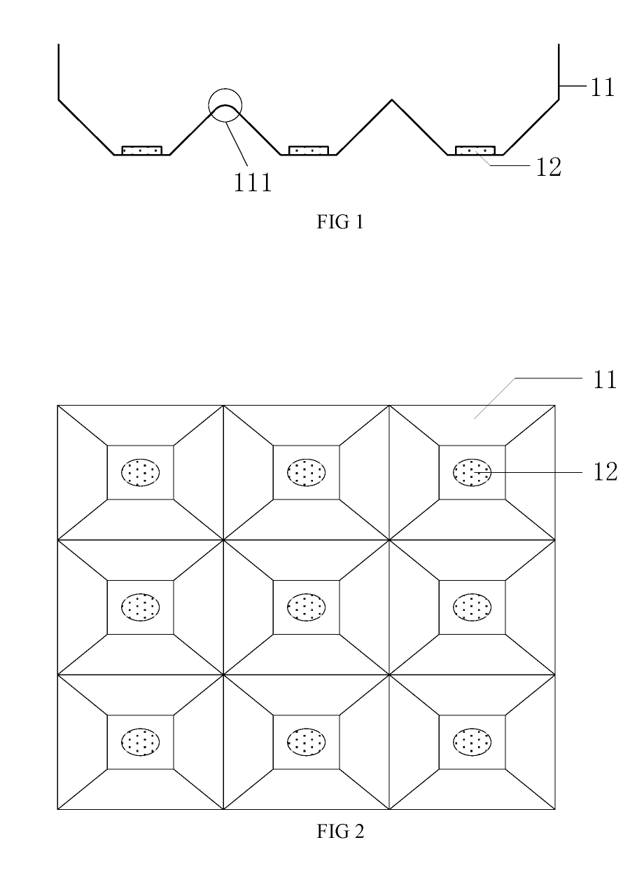

With reference to FIG. 1, and FIG. 1 is a side view of a structure of a backlight module of a first embodiment of the present invention. The backlight module includes a back plate 11 and a light source 12. The back plate 11 includes multiple concave units arranged as a matrix. The light source 12 is disposed at a bottom surface of each concave unit.

Optionally, the back plate 11 can be made of a metal material such as aluminum or aluminum alloy that has a good thermal conductivity. Besides, the back plate 11 can also be made of a plastic material, and the back plate made of the plastic material has features of light weight and low cost.

The back plate 11 includes multiple concave units arranged as a matrix. It can be understood that the back plate 11 is formed integrally. Every adjacent two concave units are formed integrally. Optionally, the back plate 11 and the concave units are formed through stamping once. In another embodiment, the back plate 11 and the concave units can be formed by a molding method.

Optionally, because an opening of each concave unit is usually provided with other optical elements, openings of adjacent two concave units are connected smoothly to form a connection portion such that too sharp at the connection portion is avoided in order to prevent from damaging other elements. For example, the connection of the adjunct two concave units is arcuate, as shown as numeral 111 in FIG. 1.

It can be understood that because of the special shape of each concave unit, the light source 12 is equal to be disposed in a cavity structure. The light emitted from the light source 12 only irradiates toward the opening of the concave unit. Accordingly, lights emitted from light sources 12 in every two adjacent concave units will not interfere mutually.

Optionally, the light source is an LED light strip.

With further reference to FIG. 2, which is a top view of the structure of the backlight module of the first embodiment of the present invention. Wherein, the concave units are arranged horizontally and vertically. FIG. 2 only shows a 3*3 arrangement as an example. In a specific embodiment, the concave units can be disposed arbitrarily according to the brightness and color of a displayed image and a size of the display panel.

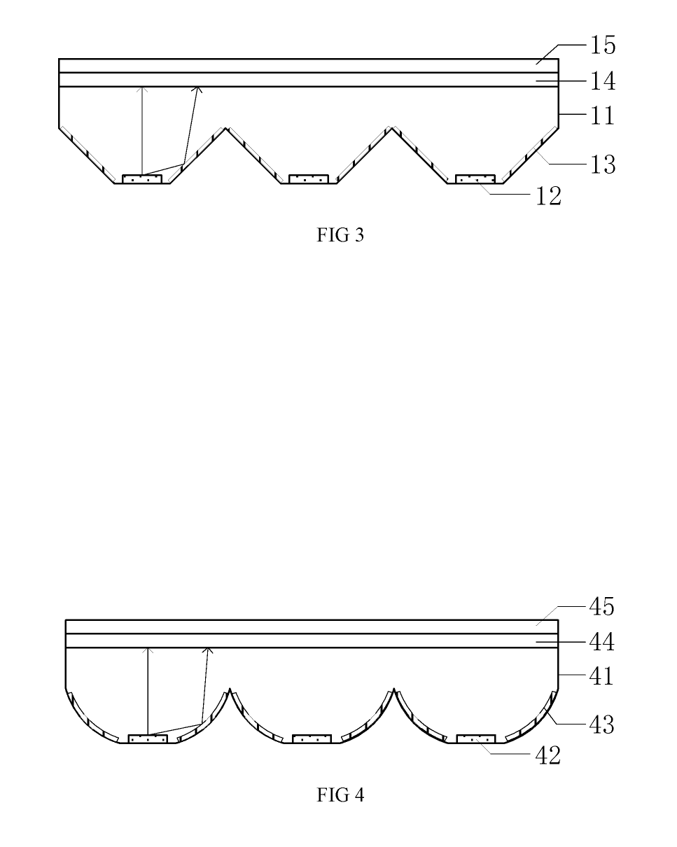

With reference to FIG. 3, which is a side view of another structure of the backlight module of the first embodiment of the present invention. Wherein, the backlight module further includes a reflective sheet 13 disposed at inner side surface of each concave unit, a diffusion plate 14 disposed above the openings of the concave units and an optical film 15 disposed at a side of the diffusion plate away from the concave units.

Wherein, the light source 12 is disposed at the bottom surface of each concave unit and the reflective sheet 13 is disposed at the inner side surface of each concave unit for reflecting the light emitted from the light source 12 such that the light emitted from the concave units can irradiate at a region of the display panel corresponding to the concave units. Adding the reflective sheet 13 is beneficial to eliminate a light shadow of the light source 12, and increase the light-emitting efficiency.

Optionally, the reflective sheet 13 can also be replaced by a layer of reflective material coated on the inner side surface of each concave unit of the back plate 11.

The diffusion sheet 14 is a light diffusion sheet having good performances of heat resistance, dimensional stability, mechanical strength, flame resistance, and having a high light transmittance, a good shielding ability and a durability such that the light diffusion effect can reach a best status, and is suitable for a direct-light type backlight source.

Specifically, the diffusion sheet 14 is used for outputting the light emitted from the light source 12 after refracting and scattering.

Optionally, the diffusion sheet 14 can be made of transparent polymeric materials such as Polystyrene (PS), polycarbonate (PC), polyethylene (PE), polypropylene (PP), polyvinyl chloride (PVC), polyethylene terephthalate (PET), acrylic (PMMA), acrylic acid (MMA), and so on or synthetic materials.

Optionally, in an embodiment, the diffusion sheet 14 is a layer of diffusion plate, or a combination of multiple diffusion plates for refracting and scattering the light many times.

The optical film 15 can be one layer or a combination of multiple layers. The optical film 15 has an optical refraction function and an optical processing function such that the backlight is more even.

Specifically, in the present embodiment, each concave unit is surrounded and formed by multiple side surfaces and one bottom surface, and an area of an opening of the concave unit is greater than an area of the bottom surface.

Wherein, as shown in FIG. 2 and FIG. 3, the bottom surface of each concave unit is a rectangular flat surface, and the side surfaces are four trapezoidal flat surfaces.

With reference to a light path in FIG. 3, a portion of the light emitted from the light source 12 directly enters the diffusion sheet 14, and the other portion of the light enters the diffusion sheet 14 after being reflected by the reflective sheet 13.

Comparing to the conventional art, the backlight module of the present invention comprises a back plate and a light source, wherein, the back plate includes multiple concave units arranged as a matrix; and the light source disposed at an inner bottom surface of each concave unit. The present invention can avoid a mutual interference of light between adjacent two concave units, capable of increasing the light controlling ability of the liquid crystal display and increasing the dynamic contrast ratio of a displayed picture.

With reference to FIG. 4, which is a side view of a structure of a backlight module of a second embodiment of the present invention. The backlight module of the present embodiment includes a back plate 41, a light source 42, a reflective sheet 43, a diffusion plate 44 and an optical film 45.

Wherein, the back plate 41 includes multiple concave units arranged as a matrix, the light source 42 is disposed at a bottom surface of each concave unit. The reflective sheet 43 is disposed at side surfaces inside each concave unit. The diffusion sheet 44 is disposed above an opening of each concave unit. The optical film 45 is disposed at a side of the diffusion plate away from the concave units.

Specifically, in the present embodiment, each concave unit is surrounded and formed by multiple side surfaces and one bottom surface. An area of the opening of the concave unit is greater than an area of the bottom surface. The bottom surface of the concave unit is a circular flat surface, and the side surfaces are arcuate surrounding surfaces.

Optionally, the radian of the arcuate surface can be disposed according to a size of the light source and a size of the concave unit in order to ensure that the light emitted from the light source 42 maximally enter a region of the diffusion plate 44 corresponding to the concave unit.

It can be understood, with reference to FIG. 5, which is a top view of the structure of the backlight module of the second embodiment of the present invention. The bottom surface 411 of the concave unit is a circular flat surface. The side surface 412 of the concave unit is connected with the bottom surface and is extended upwardly. In an extending process, the opening is increased constantly, and gradually become a rectangle from a circle such that adjacent two concave units are connected mutually.

Besides, in another embodiment, the bottom surface of the concave unit can also be an arcuate surface or a bent structure, the light source can be disposed at a center of the arcuate surface or a center of the bent structure. The side surface of the concave unit can be a flat surface or an arcuate surface. For example, when the bottom surface and the side surface of the concave unit are both arcuate surfaces, a hemispherical structure is formed. That is, the concave unit is a hemispherical structure and the light source is disposed at a center of the bottom surface of the hemispherical structure.

Besides, in another embodiment, the side surfaces of the concave unit can be a reflective surface formed by multiple flat surfaces.

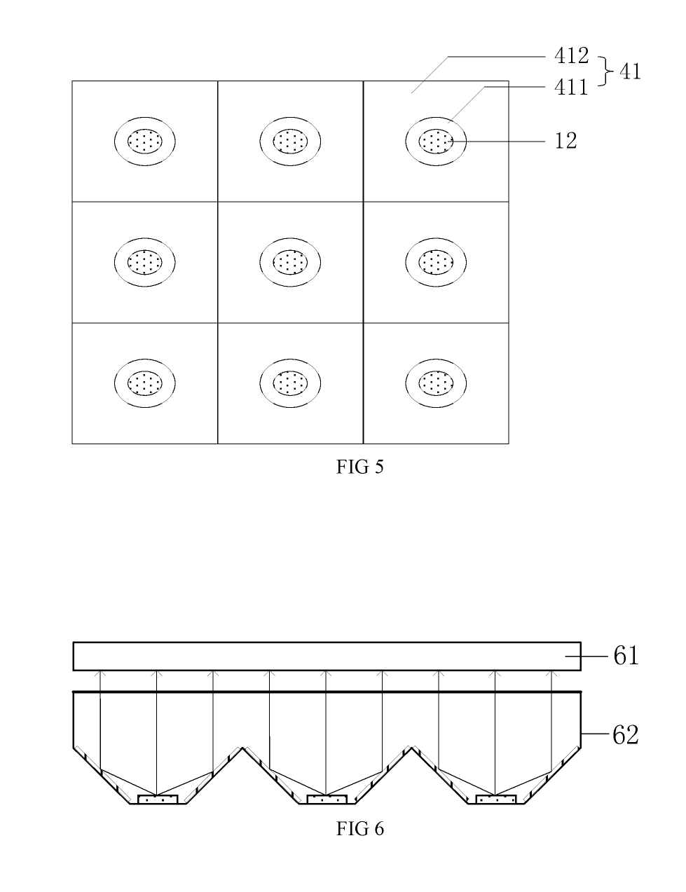

With reference to FIG. 6, which is a schematic diagram of a liquid crystal display of an embodiment of the present invention. The liquid crystal display includes a display panel 61 and a backlight module 62.

Wherein, the display panel 61 includes an array substrate, a color filter substrate and a liquid crystal layer disposed between the array substrate and the color filter substrate.

The backlight module 62 is a backlight module described at any one of the above embodiments.

Specifically, in an embodiment, the backlight module 62 includes a back plate, a light source, a reflective sheet, a diffusion plate and an optical film

Optionally, the back plate includes multiple concave units arranged as a matrix. Each concave unit is formed by one rectangular bottom surface and four trapezoidal flat surfaces. A side view is a trapezoid. The light source is disposed at an inner bottom surface of the concave unit.

Optionally, the back plate includes multiple concave units arranged as a matrix. Each concave unit is surrounded and formed by one circular bottom surface and one arcuate side surface. The light source is disposed at an inner bottom surface of the concave unit.

The specific structure of the backlight module of the present embodiment can refer to the embodiment described above, no more repeating.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal display including a display panel and a backlight module, wherein, the backlight module comprises:
a back plate including multiple concave units arranged as a matrix; and
a light source disposed at an inner bottom surface of each concave unit.

2. The liquid crystal display according to claim 1, wherein, further comprises:
a reflective sheet disposed at an inner side surface of each concave unit.

3. The liquid crystal display according to claim 1, wherein, each concave unit is surrounded and formed by multiple side surfaces and a bottom surface, an area of an opening of the concave unit is greater than an area of the bottom surface.

4. The liquid crystal display according to claim 3, wherein, the bottom surface is a flat surface or an arcuate surface, and the light source is disposed at a center of the bottom surface; or
the bottom surface is a bent structure, and the light source is disposed at a bending location of the bottom surface.

5. The liquid crystal display according to claim 3, wherein, each side surface is a flat surface or an arcuate surface.

6. The liquid crystal display according to claim 3, wherein, the number of the side surfaces is four, and both the bottom surface and the opening are rectangular.

7. The liquid crystal display according to claim 1, wherein, further comprises:
a diffusion plate disposed above openings of the multiple concave units; and
an optical film disposed at a side of the diffusion plate away from the multiple concave units.

8. The liquid crystal display according to claim 1, wherein, the multiple concave units of the back plate are formed through stamping.

9. The liquid crystal display according to claim 1, wherein, openings of every adjacent two of the multiple concave units are connected smoothly.

10. A backlight module, comprising:
a back plate including multiple concave units arranged as a matrix; and
a light source disposed at an inner bottom surface of each concave unit.

11. The backlight module according to claim 10, wherein, further comprises:
a reflective sheet disposed at an inner side surface of each concave unit.

12. The backlight module according to claim 11, wherein, each concave unit is surrounded and formed by multiple side surfaces and a bottom surface, an area of an opening of the concave unit is greater than an area of the bottom surface.

13. The backlight module according to claim 12, wherein, the bottom surface is a flat surface or an arcuate surface, and the light source is disposed at a center of the bottom surface; or
the bottom surface is a bent structure, and the light source is disposed at a bending location of the bottom surface.

14. The backlight module according to claim 12, wherein, each side surface is a flat surface or an arcuate surface.

15. The backlight module according to claim 12, wherein, the number of the side surfaces is four, and both the bottom surface and the opening are rectangular.

16. The backlight module according to claim 10, wherein, further comprises:
a diffusion plate disposed above openings of the multiple concave units; and
an optical film disposed at a side of the diffusion plate away from the multiple concave units.

17. The backlight module according to claim 10, wherein, the multiple concave units of the back plate are formed through stamping.

18. The backlight module according to claim 10, wherein, openings of every adjacent two of the multiple concave units are connected smoothly.
